(19) United States
(12) Patent Application Publication
(10) Pub. No.: US 2008/0085698 A1
(43) Pub. Date: Apr. 10, 2008

(54) DEVICE WITH UNIQUE IDENTIFIER CAPABILITY FOR PURCHASING WIRELESS COMMUNICATION SERVICE

(76) Inventor: James Gamm, Walnut Creek, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/539,854

(22) Filed: Oct. 9, 2006

(51) Int. Cl. H04Q 7/38

(52) U.S. Cl. 455/414.1

(57) ABSTRACT

A wireless device usable for prepaid wireless service is provided with the capability of requesting and receiving an identifier uniquely identifying an account associated with the wireless device. The identifier can be displayed by the wireless device. When payment to the account is desired, the identifier may be displayed and read at a point of sale terminal, which then accepts the payment and communicates the transaction to the wireless service provider. In such a manner, the account for the wireless device is properly credited by the payment amount.

### BACKGROUND

Handheld devices such as cellular phones, personal digital assistants (PDAs), and portable e-mail devices allow users to wirelessly transmit and receive one or more forms of data. For example, a cellular phone enables its user to wirelessly speak with another individual. With a PDA, for example, a user can wirelessly send and receive e-mail and/or browse the Internet. Those skilled in the art will note that as the overall infrastructure for supporting wireless communications continues to expand, the availability of wireless communication service (“wireless service”) and the number of wireless handheld devices in use will commensurately increase.

Traditionally, one wishing to obtain wireless service has had to submit a credit application to the wireless service provider. If the credit application is approved, the customer signs a contract promising to remain a subscriber for some predetermined amount of time (e.g., for one year). Then, the wireless service provider regularly (e.g., monthly) sends a statement to the customer billing the customer for charges incurred during the previous billing period. The charges generally include a rate for a pre-selected service usage plan, charges for additional used services (e.g., operator-assisted calls, text messages, service downloads, Internet usage, long distance calls), and one or more various fees and taxes. The customer can then pay the bill by returning a check through postal mail, paying on-line via check, credit card, or debit card, making a payment over the phone, or having the billed charges be deducted from an amount previously deposited by the customer.

While the subscribing and billing scheme described above is satisfactory for some customers of wireless service providers, it has a number of features that many potential and current customers find undesirable or disadvantageous. For example, a potential customer may have poor credit, thereby making it unlikely that he/she will be approved for wireless service. In another example, one may not wish to affect his/her credit score by submitting a credit application. Moreover, a potential customer may not want to be locked into a contract or face a heavy penalty for later changing wireless service providers. In still another example, because a service usage plan is generally pre-selected, a customer may find it undesirable to be forced to pay for services not used during the previous billing period.

In an effort to address many of the shortcomings associated with traditional wireless service plans, prepaid wireless services plans allow customers to pay for wireless service on a “pay as you go” basis. Under such an arrangement, a customer (or “subscriber”) initially deposits some amount of money (or other form of credit) into their account. As the customer uses wireless services, the customer's account is debited based on his/her usage (or other pricing system). Usage of wireless services may include any one or more of voice calls, data transfers (e.g., text messages, Internet browsing, e-mail), and the downloading of content (e.g., games, ring tones, images). The customer may use the wireless services as desired until his/her account balance is depleted, reaches a particular minimum threshold, or is insufficient for a particular requested wireless service. In such cases, the customer may add funds (or other form of credit) to his/her account to receive requested wireless services.

Various mechanisms are available to replenish funds in a customer's prepaid wireless service account. For example, a customer may pay on-line via a checking account, credit card, or debit card. Moreover, a customer may add funds by calling the prepaid wireless service provider. In still another example, a customer may use his/her wireless device to pay by selecting a preapproved checking account, credit card, or debit card. However, these various mechanisms fail to address those situations in which, for example, the customer does not have access to the Internet, wishes not to waste time calling the wireless service provider, is unable to locate a phone number to the wireless service provider, does not have a preapproved checking account, credit card, or debit card, or does not have time to go through the preapproval process.

Another way to facilitate prepaid wireless service involves the use of “top-up” cards, which are physical cards associated with accounts, whereby the physical cards can be used to add funds to the associated accounts. For example, a customer may purchase a top-up card for his/her prepaid wireless service account. The top-up card has a value associated with it, the value likely being equal to that paid by the customer for the top-up card (less, for example, a nominal service, purchase, and/or activation fee). When funds in the wireless account associated with the top-up card reach a particular level or if the customer otherwise wishes, the customer can use information on that card to add funds to the account via phone, the Internet, or at a point of sale (POS) terminal. In the case of a point of sale terminal, the customer would provide the top-up card and payment in order to have the payment be credited to his/her account. However, use of such cards requires the customer to purchase and maintain the cards, and from the perspective of the card provider, an infrastructure must be in place to manufacture, inventory, distribute, and track the cards.

### SUMMARY

According to at least one aspect of one or more embodiments of the present invention, a method of prepaying for wireless service is described. The method includes requesting with a wireless device an identifier uniquely identifying an account associated with the wireless device. The method then includes receiving the identifier with the wireless device. The method further includes displaying with the wireless device the identifier at a point of sale terminal, where the identifier is readable by the point of sale terminal, and where an associated payment at the point of sale terminal results in a credit to the account based on reading the identifier.

According to at least one other aspect of one or more embodiments of the present invention, a system for facilitating prepaid wireless service is described. The system includes a wireless device adapted for use by a subscriber of the prepaid wireless service, where the wireless device is arranged to request and display an identifier uniquely identifying an account associated with the subscriber. The system further includes a point of sale terminal arranged to read the identifier. Payment by the subscriber and display of the identifier at the point of sale terminal results in a credit to the subscriber's account.

According to at least one other aspect of one or more embodiments of the present invention, a wireless device is described. The wireless device includes a processor, a memory operatively connected to the processor, and instructions stored in the memory and executable by the processor. The instructions are to request a machine-readable identifier uniquely identifying a wireless service account associated with the wireless device and display the machine-readable identifier via a user interface of the wireless device.

The features and advantages described herein are not all inclusive, and, in particular, many additional features and advantages will be apparent to those skilled in the art in view of the following description. Moreover, it should be noted that the language used herein has been principally selected for readability and instructional purposes and may not have been selected to circumscribe the present invention.

### BRIEF DESCRIPTION OF DRAWINGS

FIG. 1 shows a system in accordance with an embodiment of the present invention.

FIG. 2 shows use of a wireless device in accordance with an embodiment of the present invention.

FIG. 3 shows use of a wireless device in accordance with an embodiment of the present invention.

FIG. 4 shows a flow process in accordance with an embodiment of the present invention.

Each of the figures referenced above depict an embodiment of the present invention for purposes of illustration only. Those skilled in the art will readily recognize from the following description that one or more other embodiments of the structures, methods, and systems illustrated herein may be used without departing from the principles of the present invention.

### DETAILED DESCRIPTION

In the following description of embodiments of the present invention, numerous specific details are set forth in order to provide a more thorough understanding of the present invention. However, it will be apparent to one skilled in the art that the present invention may be practiced without one or more of these specific details. In other instances, well-known features have not been described in detail to avoid unnecessarily complicating the description.

In general, embodiments of the present invention relate to a system and method for prepaying for wireless service using an identifier displayed using the wireless device for which the wireless service is sought. More particularly, in one or more embodiments, a customer may use his/her wireless device to download a unique identifier linked to the customer's account. The unique identifier may be displayed on the wireless device and presented to, for example, a point of sale terminal at a retail establishment. The customer may then pass funds to the retail establishment, whereby the funds are effectively added to the customer's account via the association between the displayed unique identifier and the customer's account.

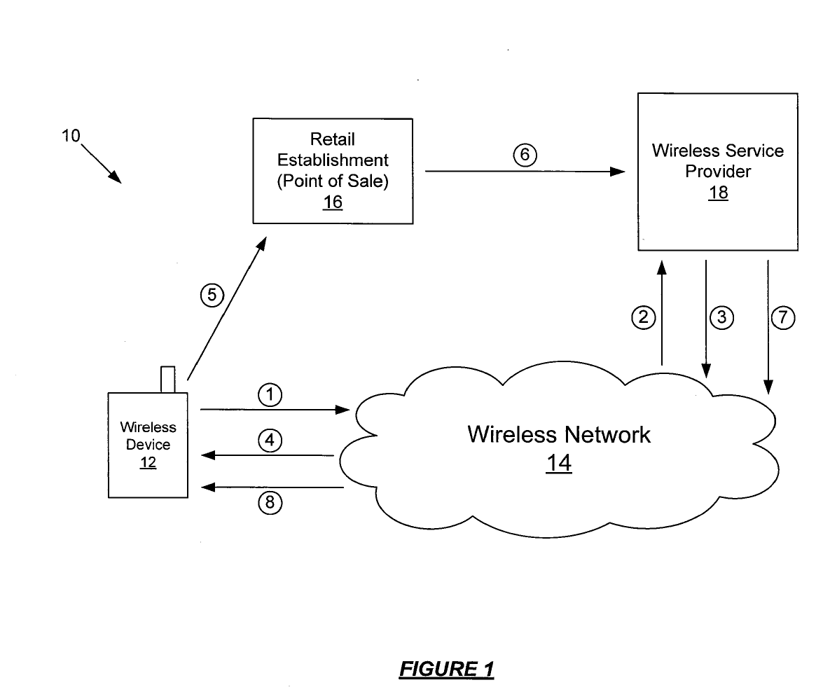

FIG. 1 shows a system 10 in accordance with an embodiment of the present invention. The system 10 involves a wireless device 12. The wireless device 12 may be any type of handheld device capable of wirelessly receiving and/or transmitting data. For example, the wireless device 12 may be a cellular phone for communicating voice data. Moreover, the wireless device 12 may be a PDA enabled to communicate, for example, Internet-based data. In still another example, the wireless device 12 may be a portable e-mail device arranged to send and receive e-mail.

Further, the wireless device 12 may wirelessly communicate via one or more of various wireless protocols. For example, the wireless device 12 may communicate voice data based on code division multiple access (CDMA) technology. Moreover, the wireless device 12 may communicate via an 802.11-based standard. In still another example, the wireless device 12 may communicate data using radio signals.

The wireless device 12 is in effective communication with a wireless network 14. The wireless network 14 may be any type of network. For example, the wireless network 14 may be a cellular-based network. Moreover, the wireless network 14 may be a local area network (LAN). In still another example, the wireless network 14 may a wide area network (WAN). Moreover, the wireless network 14 may be a satellite-based network.

The wireless network 14 is in effective communication with a wireless service provider 18 via any one or combination of the various protocols and technologies described above. As used herein, the “wireless service provider” 18 may be, for example, any one or more of a server, a database, a computer system, and a corporate or retail establishment. In general, the wireless service provider 18 provides wireless service for the wireless device 12. As such, the wireless service provider 18 may maintain an account associated with the wireless device 12. Should there be insufficient funds in the account for a wireless service requested by the wireless device 12, the wireless service provider 18 may at least temporarily suspend wireless service until the account is sufficiently replenished.

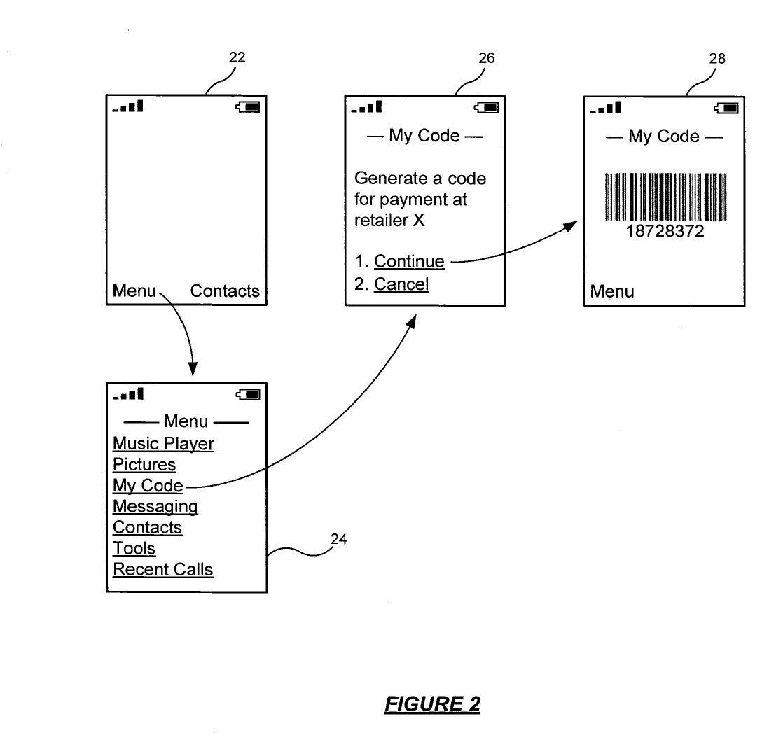

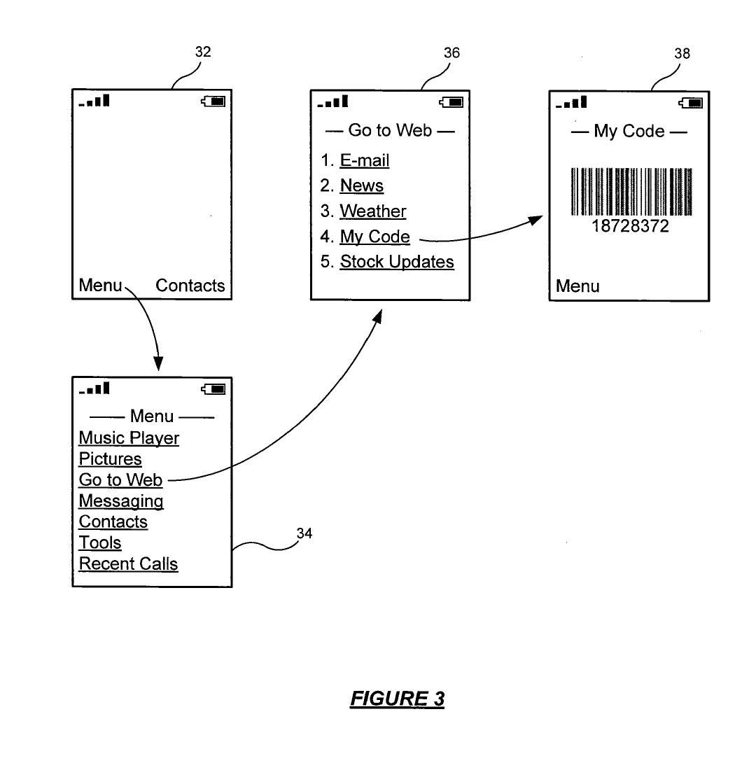

In cases when, for example, (i) a wireless service requested by the customer is denied for lack of sufficient funds, (ii) the customer wishes to add funds to his/her account, or (iii) the wireless service provider 18 sends a “low funds” message to the wireless device 12, the customer may use the wireless device 12 to initiate a payment process in accordance with one or more embodiments. The payment process begins with the customer using his/her wireless device 12 to request to download an identifier uniquely identifying the account associated with the wireless device 12 (further described below with reference to FIGS. 2 and 3). The request is sent to the wireless service provider 18 over the wireless network 14.

In response to the request from the wireless device 12, the wireless service provider 18 identifies the particular wireless device 12 as being the source of the request based on information (e.g., packet header data) in the request. The wireless service provider 18 accordingly generates or retrieves an identifier uniquely identifying the account associated with the wireless device 12.

In general, the identifier generated or retrieved by the wireless service provider 18 encodes information identifying the account associated with the wireless device 12. In one or more embodiments, the identifier may encode other information. For example, the identifier may encode the current account balance. Moreover, the identifier may encode information relating to an identity of the customer (e.g., name, address, phone number, date of birth, social security number). In still another example, the identifier may encode information relating to the customer's payment history or a maximum/minimum payment amount.

The identifier generated or retrieved by the wireless service provider 18 may be in one or more of various forms. For example, the identifier may be a computer-readable bar code. Those skilled in the art will note that various types of standard or custom bar codes may be used—numeric-only, alphanumeric, two-dimensional, etc. Moreover, in one or more embodiments, the identifier may be a computer-readable label or image.

Still referring to FIG. 1, the identifier generated or retrieved by the wireless service provider 18 is sent to the wireless device 12 over wireless network 14. Once received, the wireless device 12 may then be used to display the identifier on a screen of the wireless device 12 (further described below with reference to FIGS. 2 and 3).

The identifier may be displayed at a point of sale terminal of a retail establishment 16. The point of sale terminal 16 is equipped to read the displayed identifier. For example, the point of sale terminal 16 may be provided with a bar code reader for reading bar code type identifiers.

The point of sale terminal 16 (and more generally, the retail establishment) is in effective communication with the wireless service provider 18. The communication between the point of sale terminal 16 and the wireless service provider 18 may be wired or wireless. For example, the point of sale terminal 16 and the wireless service provider 18 may be connected over the Internet via a dedicated connection (e.g., a T1 line, a cable modem, a digital subscriber line (DSL)). Moreover, in one or more other embodiments, the point of sale terminal 16 and the wireless service provider 18 may communicate over the wireless network 14. In still another example, the point of sale terminal 16 may communicate with the wireless service provider 18 via non-computer means, such as by postal mail, by telephone, or by person.

In addition to displaying the identifier as part of the payment process, the customer provides funds at the point of sale terminal 16. The funds may be paid by, for example, cash, check, credit card, debit card, money order, or traveler's check. The payment is accepted at the point of sale terminal 16, and then, the amount of the payment and the identifier are communicated to the wireless service provider 18. In response, the wireless service provider 18 applies the payment amount (less any service fees due for use of the point of sale terminal 16 to make the payment) to the account uniquely identified by the identifier.

Once the customer's account has been credited, the wireless service provider 18 may allow wireless service requests previously denied due to a lack of sufficient funds. Moreover, in one or more embodiments, upon payment to the customer's account, the wireless service provider 18 may transmit an electronic receipt to the wireless device 12 confirming the payment, including, for example, the amount of the payment, the method of payment, the location of the payment, the date and time of the payment, and/or the account balance after the payment.

Still referring to FIG. 1, flow of information through the system 10 is shown using arrows 1-8 in accordance with one or more embodiments. Arrow 1 indicates a request for an identifier sent from the wireless device 12. Arrow 2 indicates passage of the request from the wireless network 14 to the wireless service provider 18. Arrow 3 indicates the identifier being sent from the wireless service provider 18 to the wireless network 14. Arrow 4 indicates passage of the identifier from the wireless network 14 to the wireless device 12. Arrow 5 indicates display of the identifier with the wireless device 12 at a point of sale terminal 16. Arrow 6 indicates communication of payment and identifier information from the point of sale terminal 16 to the wireless service provider 18. Arrow 7 indicates an electronic receipt confirming the payment being sent from the wireless service provider 18 to the wireless network 14. Arrow 8 indicates delivery of the electronic receipt to the wireless device 12 from the wireless network 14.

FIG. 2 shows use of a wireless device 12 in accordance with an embodiment of the present invention. Externally, the wireless device 12 has a screen and input means (e.g., buttons). Internally, the wireless device 12 has at least one processor (not shown) for executing computer-readable instructions stored in a memory (not shown) of the wireless device 12. The customer, via a user interface (IU) displayed on the screen, may request to download the identifier based on executing instructions supporting a wireless application protocol (WAP). Those skilled in the art will note that WAP is a secure specification that allows users to quickly access information via handheld wireless devices.

Referring to FIG. 2, at UI 22, the customer may select “Menu” to go to a listing of various selectable features supported by the wireless device 12. At UI 24, from among various features, the customer may select “My Code”. Then, at UI 26, the customer is provided with the option of continuing with the request to download an identifier, or otherwise canceling the request. If the customer wishes to go forward with the request, then, at UI 28, the identifier is displayed for subsequent presentation to a point of sale terminal (e.g., 16 in FIG. 1).

FIG. 3 shows use of a wireless device 12 in accordance with an embodiment of the present invention. The customer, via a user interface (IU) displayed on the screen of the wireless device 12, may request to download the identifier based via a web browser, or, in other words, over the Internet.

Referring to FIG. 3, at UI 32, the customer may select “Menu” to go to a listing of various selectable features supported by the wireless device 12. At UI 34, from among various features, the customer may select “Go to Web” for accessing the Internet. Then, at UI 36, the customer is provided with the option of selecting “My Code” to request to download the identifier. If and when the “My Code” option is selected, then, at UI 38, the identifier is displayed for subsequent presentation to a point of sale terminal (e.g., 16 in FIG. 1).

Further, the various features and options shown in the UIs of FIGS. 2 and 3 for initiating an identifier request may be selected using various types of input means provided with or by the wireless device 12. For example, a wireless device may be provided with a scroll wheel for selecting particular features. Moreover, in one or more embodiments, a wireless device may select a feature based on voice command. In still another example, a wireless device may be used to select a feature using a stylus or by touch.

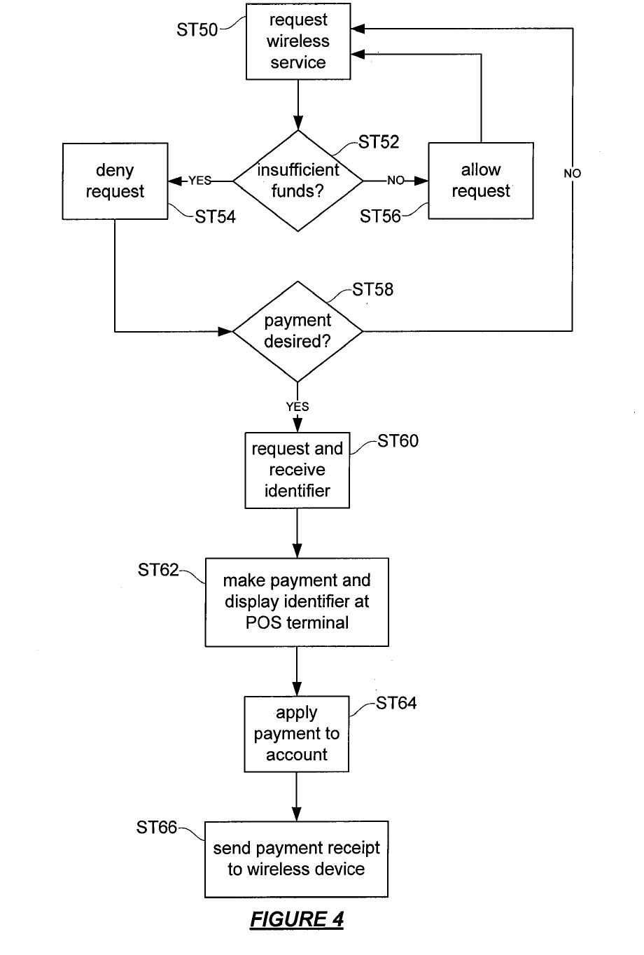

FIG. 4 shows a flow process in accordance with an embodiment of the present invention. Initially, a wireless device 12 requests a wireless service ST50. If there is are insufficient funds in the customer's account for the requested wireless service ST52, the request is denied ST54 and the customer is allowed to choose to make a payment ST58. Otherwise, if there are sufficient funds for the requested wireless service ST52, the request is allowed ST56.

If the customer wishes to make a payment ST58, an identifier is requested and retrieved as described above with reference to FIGS. 1-3 ST60. Thereafter, the customer, at a point of sale terminal of a participating retail establishment, may make a payment and use the wireless device 12 to display the downloaded identifier ST62. The payment amount is then effectively applied to the customer's account, which was uniquely identified based on the point of sale terminal reading the displayed identifier ST64. The wireless service provider 18 then transmits an electronic receipt to the wireless device 12 to confirm the payment.

Further, those skilled in the art will note that in one or more embodiments, funds may be added to a customer's wireless service account in cases other then when the account has insufficient funds. In other words, the customer may add funds to his/her account at any time. For example, if the customer is about go on a trip where he/she will not have access to the Internet or a point of sale terminal for making payment, he/she may make a relatively large payment so as not to be inconvenienced with having to make any payments during the trip.

Advantages of the present invention may include one or more of the following. In one or more embodiments, a wireless device may be used to make payments for prepaid wireless services. Further, the payment amount may be selectable by the customer.

Further, in one or more embodiments, a wireless device may be used to allow a customer to make a cash payment that is instantly credited to an account for the wireless device.

Further, in one or more embodiments, a wireless device may be used to allow a customer to make an instant payment to an account for the wireless device, where the instant payment is made via a credit or debit card not previously approved by the wireless service provider.

Further, in one or more embodiments, a wireless device may be used to request and display an identifier that uniquely identifies an account associated with the wireless device. The identifier may be displayed at a point of sale terminal, where the customer may make a cash or non-cash payment that is instantly, or at least promptly, applied to the account (which is identified by the displayed identifier).

While the invention has been described with respect to a limited number of embodiments, those skilled in the art, having benefit of the above description, will appreciate that other embodiments may be devised which do not depart from the scope of the present invention as described herein. Accordingly, the scope of the present invention should be limited only by the appended claims.

What is claimed is:

1. A method of prepaying for wireless service, comprising:
requesting with a wireless device an identifier uniquely identifying an account associated with the wireless device; and
receiving the identifier with the wireless device; and
displaying with the wireless device the identifier at a point of sale terminal, the identifier readable by the point of sale terminal, wherein an associated payment at the point of sale terminal results in a credit to the account based on reading the identifier.

2. The method of claim 1, wherein the identifier is a bar code.

3. The method of claim 1, wherein the identifier is at least one of an image and a label.

4. The method of claim 1, wherein the identifier is requested via a wireless application protocol.

5. The method of claim 1, wherein the identifier is requested via a web browser.

6. The method of claim 1, further comprising:
receiving with the wireless device an electronic receipt confirming the payment.

7. The method of claim 1, wherein the wireless device is one of a cellular phone, a personal digital assistant, and a portable e-mail device.

8. The method of claim 1, further comprising:
specifying an amount of the payment.

9. A system for facilitating prepaid wireless service, comprising:
a wireless device adapted for use by a subscriber of the prepaid wireless service, wherein the wireless device is arranged to request and display an identifier uniquely identifying an account associated with the subscriber; and
a point of sale terminal arranged to read the identifier,
wherein payment by the subscriber and display of the identifier at the point of sale terminal results in a credit to the account.

10. The system of claim 9, wherein the identifier is a bar code.

11. The system of claim 9, wherein the identifier is at least one of an image and a label.

12. The system of claim 9, wherein the wireless device is one of a cellular phone, a personal digital assistant, and a portable e-mail device.

13. The system of claim 9, wherein the payment is in a form of at least one of cash, credit card, debit card, traveler's check, money order, and check.

14. The system of claim 9, further comprising:
a provider of the prepaid wireless service, wherein the provider is arranged to provide the wireless device with the identifier.

15. The system of claim 14, wherein the provider is further arranged to maintain the account.

16. The system of claim 14, wherein the provider is further arranged to transmit to the wireless device an electronic receipt confirming the payment.

17. The system of claim 14, wherein the point of sale terminal is operatively connected to the provider, and wherein the point of sale terminal is further arranged to transmit to the provider information relating to the payment.

18. The system of claim 9, wherein the identifier is requested via at least one of a wireless application protocol and the Internet.

19. A wireless device, comprising:
a processor;
a memory operatively connected to the processor; and
instructions stored in the memory and executable by the processor to:
request a machine-readable identifier uniquely identifying a wireless service account associated with the wireless device, and
display the machine-readable identifier via a user interface of the wireless device.

20. The wireless device of claim 19, wherein a credit to the account is at least partly based on displaying the machine-readable identifier to a point of sale terminal in effective communication with a wireless service provider maintaining the account.

21. The wireless device of claim 19, wherein the wireless device is one of a cellular phone, a personal digital assistant, and a portable e-mail device.

22. The wireless device of claim 19, wherein the machine-readable identifier is requested via at least one of a wireless application protocol and the Internet.

23. The wireless device of claim 19, wherein the machine-readable identifier is a bar code.

24. The wireless device of claim 19, wherein the machine-readable identifier is at least one of an image and a label.
